(19) United States
(12) Patent Application Publication
(10) Pub. No.: US 2007/0026751 A1
(43) Pub. Date: Feb. 1, 2007

(54) Papermachine fabric

(76) Inventor: Arved Westerkamp, Dettingen (DE)

Correspondence Address: VOITH FABRICS, 3040 BLACK CREEK ROAD, P.O. BOX 1411, WILSON, NC, 27893, US

(21) Appl. No.: 11/494,324

(22) Filed: Jul. 27, 2006

(30) Foreign Application Priority Data
Jul. 29, 2005 (DE) 10 2005 035 559.5

(51) Int. Cl. B32B 3/00

(52) U.S. Cl. 442/59

(57) ABSTRACT

A fabric for a paper machine treated on at least one side with a surface-enlarging coating, whose penetration depth, based on the total thickness of the fabric provided with the coating, lies in a range from greater than 0 to about 95%.

### CROSS-REFERENCE TO RELATED APPLICATIONS

The present application claims priority under 35 U.S.C. §119 of German Patent Application No. 10 2005 035 559.5 filed on Jul. 29, 2005, the disclosure of which is expressly incorporated by reference herein in its entirety.

### BACKGROUND OF THE INVENTION

1. Field of the Invention

The invention relates to a fabric for a paper machine. More specifically, the invention relates to a forming fabric, a press felt or a dryer fabric.

2. Discussion of Background Information

The changes in the paper machines necessitated by the development of papermachine technology lead to changes in the product portfolio (e.g. additional transfer belts) and the clothing technology applied to the paper machines.

In order to be able to satisfy the requirements resulting in particular at the higher machine running speeds and higher quality demands of the end users on the end product paper, fabrics are used to an increasingly more widespread extent in which the properties, for example in relation to the smoothness and the contact area, are changed in a lasting manner by coatings, in particular on the side of the fabric touching the paper.

### SUMMARY OF THE INVENTION

The invention is based on the object of providing an improved fabric for a paper machine. In this case, in particular as a result of the production of the highest possible adhesive forces, the most optimal adhesion of a respective two-dimensional coating to the fabric is to be ensured. To this end, for the various fabrics, in particular the respectively optimal penetration depths for the coating are also to be specified.

According to the invention, this object is achieved in that the fabric is provided on at least one side with a surface-enlarging coating, whose penetration depth, based on the total thickness of the fabric provided with the coating, lies in a range from 0 to about 95%.

The penetration depth is to be understood to be the ratio of the total thickness of the carrier material to be coated to the average maximum thickness extent of the coating in the z direction. The coatings can be applied in all possible aggregate states, for example liquid, solid, and so on, and by using various application methods, such as spraying, scattering, doctoring, dipping, padding, printing and so on, using different coating devices. In this connection, a coating is to be understood, for example, to be a permeable or impermeable layer of at least one viscous material or at least one dispersion on a carrier substrate.

The materials used for the coatings are preferably chosen in such a way that they can be applied to the respective two-dimensional structures by the application methods mentioned previously. In specific cases, the selected coating materials must also have specific release properties, as they are known. In addition, they should also satisfy the respective requirements on the creep resistance. The relevant materials can, for example, comprise polyurethane and/or silicone.

The fabric is preferably provided with an appropriate coating, at least on its side touching the paper. In principle, however, fabrics coated on both sides are also conceivable.

The fabric is preferably at least partly formed by a woven fabric and/or by a laid scrim and/or by a knit and/or by a knitted fabric.

In order to achieve adhesion or bonding between the coating and fabric, the fabric is advantageously pre-treated with a primer or an adhesion promoter. With such a pre-treatment by means of a primer or adhesion promoter, a force fit is therefore achieved with which the penetration depth and therefore the amount of coating compound needed can be reduced considerably. Accordingly, in most conventional fabrics, the coatings are substantially applied to the fabrics only with a form fit.

The respective fabric can be formed by a forming fabric, for example. The penetration depth of the coating on the side touching the paper, based on the total thickness of the fabric, can lie here in particular in a range from 0 to 95%, but preferably at least substantially corresponding only to the thickness of the thread provided on the side of the fabric touching the paper and oriented transversely with respect to the running direction of the fabric.

In this case, the total thickness of the forming fabric provided with the coating advantageously lies in a range from about 0.4 to about 1.8 mm, the penetration depth of the coating, based on the total thickness of the forming fabric, lying in a range from about 0.38 to about 1.71 mm. The embedment of a respective thread on the side of the fabric touching the paper expediently lies in a range from about 0.10 to about 0.25 mm.

A further advantageous embodiment of the fabric according to the invention, formed by a forming fabric, for example, is distinguished by the fact that the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric. In this case, the penetration depth of the coating advantageously lies at least substantially in a range from about 0.20 to about 0.50 mm.

In particular in the case of such a forming fabric, the penetration depth of the coating provided on the side of the fabric touching the paper can expediently also correspond at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus a proportion of the threads provided toward the papermachine side and oriented transversely. In this case, the penetration depth of the coating advantageously lies at least substantially in a range from about 0.30 to about 1.60 mm.

According to a further advantageous embodiment of the fabric according to the invention, formed by a forming fabric, for example, the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus the sum of the thicknesses of the threads provided toward the papermachine side and oriented transversely with respect to the running direction of the fabric and oriented in the running direction of the fabric. In this case, the penetration depth of the coating advantageously lies at least substantially in a range from about 0.40 to about 1.71 mm.

As already mentioned, the fabric according to the invention can also be formed by a press felt, for example. In this case, the penetration depth of the coating, based on the total thickness of the fabric provided with the coating, expediently lies in a range from 0 to about 70%.

In the case of the fabric formed by a press felt, it is advantageous if the coating is primarily incorporated into the top fiber layers of the press felt. In this case, the coating can in particular reach into the press felt to such an extent that it touches the reinforcing structures of the press felt.

The fabric formed by a press felt, for example, can in particular also be coated on both sides. Starting from a maximum total thickness of the press felt of about 5 mm, the preferred penetration depth of the coating, both on the side of the fabric touching the paper and on the papermachine side, in each case lies in a range from about 0.1 to about 3.5 mm.

As already mentioned, the fabric according to the invention can in particular also be formed by a dryer fabric.

In this case as well, the penetration depth of the coating, in particular on the side of the fabric touching the paper, based on the total thickness of the fabric, can in principle again lie in particular in a range from 0 to about 95%. However, the penetration depth of the coating provided on the side touching the paper corresponds preferably at least substantially only to the thickness of the thread provided on the side of the fabric touching the paper and oriented transversely with respect to the running direction of the fabric.

In this case, the total thickness of the dryer fabric provided with the coating preferably lies in a range from about 1.2 to about 2.8 mm, the penetration depth of the coating, based on the total thickness of the dryer fabric, lying in a range from about 1.14 to about 2.66 mm. The embedment of a respective thread on the side of the fabric touching the paper advantageously lies in a range from about 0.10 to about 0.70 mm.

In a further advantageous embodiment of the fabric according to the invention formed by a dryer fabric, for example, the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric. The penetration depth of the coating here preferably lies at least substantially in a range from about 0.30 to about 1.20 mm.

A further advantageous embodiment of the fabric according to the invention formed by a dryer fabric, for example, is distinguished by the fact that the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus a proportion of the threads provided toward the papermachine side and oriented transversely. In this case, the penetration depth of the coating preferably lies at least substantially in a range from about 1.00 to about 2.20 mm.

A further advantageous embodiment of the fabric according to the invention formed by a dryer fabric, for example, is distinguished by the fact that the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus the sum of the thicknesses of the threads provided toward the papermachine side and oriented transversely with respect to the running direction of the fabric and in the running direction of the fabric. In this case, the penetration depth of the coating advantageously lies at least substantially in a range from about 1.20 to about 2.8 mm.

The fabric can in particular also be formed by a dryer fabric produced by means of spiralizing technology. In this case as well, the penetration depth of the coating, in particular on the side touching the paper, based on the total thickness of the fabric, can in principle again lie in particular in a range from 0 to about 95%, but the penetration depth preferably amounting to about 70% of the maximum deflection of the spirals.

### BRIEF DESCRIPTION OF THE DRAWINGS

The present invention if further described in the detailed description which follows, in reference to the noted drawing by way of non-limiting example of exemplary embodiment of the present invention, and wherein:

FIG. 1 shows various coating penetration depths.

### DETAILED DESCRIPTION

The particulars shown herein are by way of example and for purposed of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

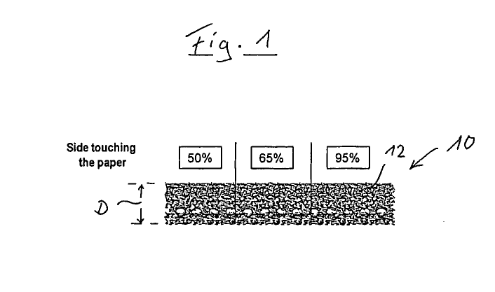

The single figure of the drawing shows various penetration depths of a respective coating in the case of press felts, by way of example. The respective fabric 10 in the present case is therefore formed by a press felt, for example. The coating 12 here is provided, for example, on the side of the fabric 10 touching the paper. According to FIG. 1, the penetration depth of the coating 12, based on the total thickness D of the fabric 10, is, for example, 50%, 65% or 95%.

The fabric 10 is provided on at least one side with a surface-enlarging coating 12, whose penetration depth, based on the total thickness of the fabric provided with the coating, lies in a range from 0 to about 95%.

The penetration depth is to be understood to be the ratio of the total thickness of the carrier material to be coated to the average maximum thickness extent of the coating in the z direction. The coatings can be applied in all possible aggregate states, for example liquid, solid, and so on, and by using various application methods, such as spraying, scattering, doctoring, dipping, padding, printing and so on, using different coating devices. In this connection, a coating is to be understood, for example, to be a permeable or impermeable layer of at least one viscous material or at least one dispersion on a carrier substrate.

The materials used for the coatings are preferably chosen in such a way that they can be applied to the respective two-dimensional structures by the application methods mentioned previously. In specific cases, the selected coating materials must also have specific release properties, as they are known. In addition, they should also satisfy the respective requirements on the creep resistance. The relevant materials can, for example, comprise polyurethane and/or silicone.

The fabric is preferably provided with an appropriate coating, at least on its side touching the paper. Fabrics coated on both sides are also conceivable.

The fabric 10 is preferably at least partly formed by a woven fabric and/or by a laid scrim and/or by a knit and/or by a knitted fabric.

In order to achieve adhesion or bonding between the coating and fabric, the fabric 10 is advantageously pre-treated with a primer or an adhesion promoter. With such a pre-treatment by means of a primer or adhesion promoter, a force fit is therefore achieved with which the penetration depth and therefore the amount of coating compound needed can be reduced considerably. Accordingly, in most conventional fabrics, the coatings are substantially applied to the fabrics only with a form fit.

The respective fabric can be formed by a forming fabric, for example. The penetration depth of the coating on the side touching the paper, based on the total thickness of the fabric, can lie here in particular in a range from 0 to 95%, but preferably at least substantially corresponding only to the thickness of the thread provided on the side of the fabric touching the paper and oriented transversely with respect to the running direction of the fabric.

In this case, the total thickness of the forming fabric provided with the coating advantageously lies in a range from about 0.4 to about 1.8 mm, the penetration depth of the coating, based on the total thickness of the forming fabric, lying in a range from about 0.38 to about 1.71 mm. The embedment of a respective thread on the side of the fabric touching the paper expediently lies in a range from about 0.10 to about 0.25 mm.

A further advantageous embodiment of the fabric according to the invention, formed by a forming fabric, for example, is distinguished by the fact that the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric. In this case, the penetration depth of the coating advantageously lies at least substantially in a range from about 0.20 to about 0.50 mm.

In particular in the case of such a forming fabric, the penetration depth of the coating provided on the side of the fabric touching the paper can expediently also correspond at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus a proportion of the threads provided toward the papermachine side and oriented transversely. In this case, the penetration depth of the coating advantageously lies at least substantially in a range from about 0.30 to about 1.60 mm.

According to a further advantageous embodiment of the fabric according to the invention, formed by a forming fabric, for example, the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus the sum of the thicknesses of the threads provided toward the papermachine side and oriented transversely with respect to the running direction of the fabric and oriented in the running direction of the fabric. In this case, the penetration depth of the coating advantageously lies at least substantially in a range from about 0.40 to about 1.71 mm.

As already mentioned, the fabric 10 according to the invention can also be formed by a press felt, for example. In this case, the penetration depth of the coating, based on the total thickness of the fabric provided with the coating, expediently lies in a range from 0 to about 70%.

In the case of the fabric formed by a press felt, it is advantageous if the coating is primarily incorporated into the top fiber layers of the press felt. In this case, the coating can in particular reach into the press felt to such an extent that it touches the reinforcing structures of the press felt.

The fabric formed by a press felt, for example, can in particular also be coated on both sides. Starting from a maximum total thickness of the press felt of about 5 mm, the preferred penetration depth of the coating, both on the side of the fabric touching the paper and on the papermachine side, in each case lies in a range from about 0.1 to about 3.5 mm.

As already mentioned, the fabric 10 according to the invention can in particular also be formed by a dryer fabric.

In this case as well, the penetration depth of the coating, in particular on the side of the fabric touching the paper, based on the total thickness of the fabric, can in principle again lie in particular in a range from 0 to about 95%. However, the penetration depth of the coating provided on the side touching the paper corresponds preferably at least substantially only to the thickness of the thread provided on the side of the fabric touching the paper and oriented transversely with respect to the running direction of the fabric.

In this case, the total thickness of the dryer fabric provided with the coating preferably lies in a range from about 1.2 to about 2.8 mm, the penetration depth of the coating, based on the total thickness of the dryer fabric, lying in a range from about 1.14 to about 2.66 mm. The embedment of a respective thread on the side of the fabric touching the paper advantageously lies in a range from about 0.10 to about 0.70 mm.

In a further advantageous embodiment of the fabric 10 according to the invention formed by a dryer fabric, for example, the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric. The penetration depth of the coating here preferably lies at least substantially in a range from about 0.30 to about 1.20 mm.

A further advantageous embodiment of the fabric according to the invention formed by a dryer fabric, for example, is distinguished by the fact that the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus a proportion of the threads provided toward the papermachine side and oriented transversely. In this case, the penetration depth of the coating preferably lies at least substantially in a range from about 1.00 to about 2.20 mm.

A further advantageous embodiment of the fabric according to the invention formed by a dryer fabric, for example, is distinguished by the fact that the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus the sum of the thicknesses of the threads provided toward the papermachine side and oriented transversely with respect to the running direction of the fabric and in the running direction of the fabric. In this case, the penetration depth of the coating advantageously lies at least substantially in a range from about 1.20 to about 2.8 mm.

The fabric can in particular also be formed by a dryer fabric produced by means of spiralizing technology. In this case as well, the penetration depth of the coating, in particular on the side touching the paper, based on the total thickness of the fabric, can in principle again lie in particular in a range from 0 to about 95%, but the penetration depth preferably amounting to about 70% of the maximum deflection of the spirals.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LISTING OF DESIGNATIONS

10 Fabric
12 Coating
D Total thickness of the coating

1. A fabric for a paper machine comprising a surface-enlarging coating on a first fabric side wherein penetration depth of the coating is based on the total thickness (D) of the fabric provided with the coating and is in a range from greater than 0 to about 95%.

2. The fabric of claim 1, wherein the first fabric side is touching a paper.

3. The fabric of claim 1, wherein the fabric is at least partly formed by at least one of a woven fabric, a laid scrim, a knit, and a knitted fabric.

4. The fabric of claim 1, wherein, in order to achieve at least one of adhesion and bonding between the coating and the fabric, the fabric is pre-treated with a least one of a primer and an adhesion promoter.

5. The fabric of claim 1, wherein the fabric is at least one of a forming fabric, a press felt, a dryer fabric, and a spiralized dryer fabric.

6. The forming fabric of claim 5, wherein the penetration depth of the coating on the side touching the paper, based on the total thickness (D) of the fabric, lies in a range from greater than 0 to about 95%.

7. The forming fabric of claim 6, wherein the penetration depth of the coating provided on the side touching the paper at least substantially corresponds to the thickness of the thread provided on the side of the fabric touching the paper and oriented transversely with respect to the running direction of the fabric.

8. The forming fabric of claim 5, wherein the total thickness (D) of the forming fabric provided with the coating lies in a range from about 0.4 to about 1.8 mm, the penetration depth of the coating (12), based on the total thickness (D) of the forming fabric, lying in a range from about 0.38 to about 1.71 mm.

9. The forming fabric of claim 8, wherein the embedment of a respective thread on the side of the fabric touching the paper lies in a range from about 0.10 to about 0.25 mm.

10. The forming fabric of claim 5, wherein the penetration depth of the coating (12) provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric.

11. The forming fabric of claim 10, wherein the penetration depth of the coating lies at least substantially in a range from about 0.20 to about 0.70 mm.

12. The forming fabric of claim 5, wherein the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus a proportion of the threads provided toward the papermachine side and oriented transversely.

13. The forming fabric of claim 12, wherein the penetration depth of the coating lies at least substantially in a range from about 0.30 to about 1.60 mm.

14. The forming fabric of claim 5, wherein the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus the sum of the thicknesses of the threads provided toward the papermachine side and oriented transversely with respect to the running direction of the fabric and oriented in the running direction of the fabric.

15. The forming fabric of claim 14, wherein the penetration depth of the coating lies at least substantially in a range from about 0.40 to about 1.71 mm.

16. The press felt of claim 5, wherein the penetration depth of the coating, based on the total thickness (D) of the fabric provided with the coating, lies in a range from greater than 0 to about 70%.

17. The press felt of claim 5, wherein the coating is primarily incorporated into the top fiber layers of the press felt.

18. The press felt of claim 17, wherein the coating reaches into the press felt to such an extent that it touches the reinforcing structures of the press felt.

19. The press felt of claim 17, wherein the press felt has a paper rside and a machine side, and wherein the press felt is coated on both sides.

20. The press felt of claim 19, wherein the maximum total thickness of the press felt is about 5 mm and the penetration depth of the coating, both on the side of the fabric touching the paper and on the papermachine side, in each case lies in a range from about 0.1 to about 3.5 mm.

21. The dryer fabric of claim 5, wherein the penetration depth of the coating, in particular on the side of the fabric touching the paper, based on the total thickness (D) of the fabric, lies in a range from greater than 0 to about 95%.

22. The dryer fabric of claim 21, wherein the penetration depth of the coating provided on the side touching the paper corresponds at least substantially to the thickness of the thread provided on the side of the fabric touching the paper and oriented transversely with respect to the running direction of the fabric.

23. The dryer fabric of claim 5, wherein the total thickness (D) of the dryer fabric provided with the coating lies in a range from about 1.2 to about 2.8 mm, the penetration depth of the coating, based on the total thickness (D) of the dryer fabric, lying in a range from about 1.14 to about 2.66 mm.

24. The dryer fabric of claim 23, wherein the embedment of a respective thread on the side of the fabric touching the paper lies in a range from about 0.10 to about 0.70 mm.

25. The dryer fabric of claim 5, wherein the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric.

26. The dryer fabric of claim 25, wherein the penetration depth of the coating lies at least substantially in a range from about 0.30 to about 1.20 mm.

27. The dryer fabric of claim 5, wherein the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus a proportion of the threads provided toward the papermachine side and oriented transversely.

28. The dryer fabric of claim 27, wherein the penetration depth of the coating lies at least substantially in a range from about 1.00 to about 2.20 mm.

29. The dryer fabric of claim 5, wherein the penetration depth of the coating provided on the side of the fabric touching the paper corresponds at least substantially to the sum of the thickness of the thread provided on the side of the fabric touching the paper and oriented in the running direction of the fabric and the thickness of the thread provided on the side of the fabric touching the paper and oriented transversely with respect to the running direction of the fabric, plus the sum of the thicknesses of the threads provided toward the papermachine side and oriented transversely with respect to the running direction of the fabric and in the running direction of the fabric.

30. The dryer fabric of claim 29, wherein the penetration depth of the coating lies at least substantially in a range from about 1.20 to about 2.8 mm.

31. The spiralized dryer fabric of claim 5, wherein the penetration depth of the coating, in particular on the side touching the paper, based on the total thickness (D) of the fabric, lies in a range from 0 to about 95%.

32. The spiralized dryer fabric of claim 31, wherein the penetration depth of the surface-enlarging coating provided in particular on the side touching the paper amounts to about 70% of the maximum deflection of the spirals.
